(19) United States
(12) Patent Application Publication
(10) Pub. No.: US 2007/0169117 A1
(43) Pub. Date: Jul. 19, 2007

(54) Firmware loading device

(75) Inventors: Yung-Chin Hsu, Taipei (TW); Chi-Kang Hsieh, Taipei (TW); Lin-Wei Chang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/393,119

(22) Filed: Mar. 29, 2006

(30) Foreign Application Priority Data
Dec. 14, 2005 (TW) 094144206

(51) Int. Cl. G06F 9/445

(52) U.S. Cl. 717/174

(57) ABSTRACT

A firmware loading device applied to a data processing device having a host circuit board and a case for receiving the host circuit board is proposed. A plurality of firmwares corresponding to the type of the case are stored in a database. A first electrically connecting unit and a corresponding second electrically connecting unit are respectively provided on the host circuit board and the case. A detecting unit serves to detect an electrical connection relationship between the first electrically connecting unit and the second electrically connecting unit after the host circuit board is assembled in the case. A control unit serves for fetch a firmware appropriate to the case from the database and load the firmware into the host circuit board according to the electrical connection relationship between the first and second electrically connecting units detected by the detecting unit.

### FIELD OF THE INVENTION

The present invention relates to a firmware loading device, and more particularly, to a firmware loading device applied to a data processing device having a host circuit board and a case for receiving the host circuit board.

### BACKGROUND OF THE INVENTION

A firmware is a program embedded in a programmable hardware device, for example, a basic input and output system (BIOS) program. A firmware device is able to use a software tool to write data of a newly edited basic input and output system (BIOS) program into a computer. Further, a firmware device can also update different speeds for a flash memory of a modem. When the device is turned on, a power on self test (POST) is run. For example, the communication between the device itself and other devices and the operation of the device can be tested.

Referring to the firmware which is loaded into a current data processing device, the appropriate firmware is correspondingly loaded only after the assembling process of the data processing device is completed and the type of the data processing device is recognized by an engineer. Thus, such complicated manual operation not only consumes human resources but also requires a huge amount of time. Further, the firmware may be wrongly loaded due to human errors, such that an operation failure of the data processing device can be resulted. For example, as computers are usually massively assembled by manufacturers, the engineer needs to recognize the type of each of the computers and loading of the firmware (such as the basic input and output system program) one by one. When the firmware is wrongly loaded, the subsequent testing process and shipment cannot be successfully performed, so as to seriously affect the overall operation flow.

What is needed, therefore, is to provide a firmware loading device, by which a firmware with a correct edition can be loaded into a data processing device without a complex process.

### SUMMARY OF THE INVENTION

In light of the above prior-art drawbacks, a primary objective of the present invention is to provide a firmware loading device, by which a firmware with a correct edition can be automatically loaded into a data processing device without a complex process.

Another objective of the present invention is to provide a firmware loading device, by which human resources can be saved and time requirement can be reduced.

A further objective of the present invention is to provide a firmware loading device, by which the drawback that an operation failure of a data processing device is resulted as a firmware is wrongly loaded due to human errors can be eliminated.

In accordance with the foregoing and other objectives, the present invention proposes a firmware loading device applied to a data processing device having a host circuit board and a case for receiving the host circuit board. The firmware loading device comprises a database for storing a plurality of firmwares corresponding to a type of the case; a first electrically connecting unit formed on the host circuit board; a second electrically connecting unit formed on the case, wherein the second electrically connecting unit corresponds to the first electrically connecting unit; a detecting unit for detecting an electrical connection relationship between the first electrically connecting unit and the second electrically connecting unit after the host circuit board is assembled in the case; and a control unit for fetching a firmware appropriate to the case from the database and loading the firmware into the host circuit board according to the electrical connection relationship between the first electrically connecting unit and the second electrically connecting unit detected by the detecting unit.

In a preferred embodiment of the present invention, the host circuit board is a motherboard (MB). The data processing device can be selected from the group consisting of a desk top (DT), a notebook (NB), a pocket personal computer (PPC), a server, and a super computer. The database is a correlation database. The firmware is a basic input and output system (BIOS) program. The first electrically connecting unit and the second electrically connecting unit are matched gold fingers. The amount and the allocation method of gold finger pins of the second electrically connecting unit are designed corresponding to the type of the case. The allocation method of the gold finger pin of the second electrically connecting unit is designed corresponding to the type of the case. The detecting unit serves to detect the electrical connection relationship between the first electrically connecting unit and the second electrically connecting unit via the first electrically connecting unit. Referring to the loading of the firmware into the host circuit board, the firmware is loaded into a chip of the host circuit board. Furthermore, the power source of the firmware loading device is provided by the data processing device, or alternatively, by an electricity unit.

In comparison to a prior-art firmware loading device, the firmware loading device proposed in the present invention firstly memorizes a plurality of firmware corresponding to types of the case into a database. Then, a first electrically connecting unit and a corresponding second electrically connecting unit are respectively provided on the host circuit board and the case. A detecting unit subsequently serves to detect an electrical connection relationship between the first electrically connecting unit and the second electrically connecting unit after the host circuit board is assembled in the case. Lastly, a control unit serves to fetch a firmware appropriate to the case from the database and load the firmware into the host circuit board according to the electrical connection relationship between the first electrically connecting unit and the second electrically connecting unit detected by the detecting unit.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing a firmware loading device according to an embodiment of the present invention;

FIG. 2 is a schematic diagram showing a first electrically connecting unit of a firmware loading device applied to a host circuit board according to the present invention; and

FIG. 3 is a schematic diagram showing a second electrically connecting unit of a firmware loading device applied to a case according to the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

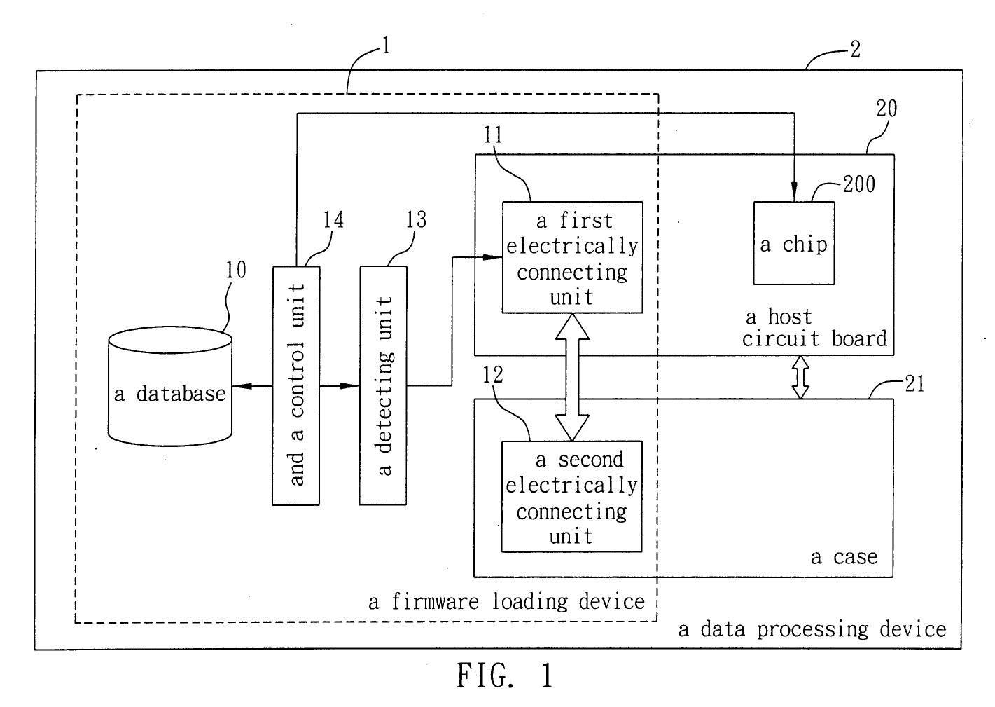

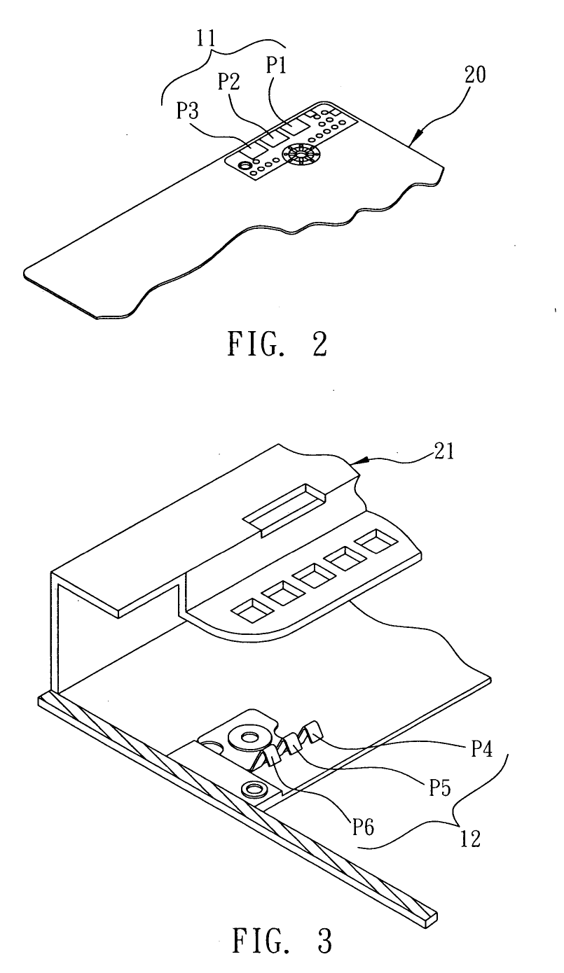

FIG. 1, FIG. 2 and FIG. 3 are relevant diagrams showing a firmware loading device according to a preferred embodiment of the present invention. These diagrams will serve to provide description for the firmware loading device proposed in the present invention. What needs to be concerned is that these drawings are simplified schematic diagrams, and thus only structures relevant to the present invention are illustrated. Also, these structures are not drawn according to actual amounts, shapes and dimensions. Actually, the amount, shape and dimension are an optional design and the arrangements of the structures may be very complex in reality.

FIG. 1 is a schematic diagram showing a firmware loading device 1 according to an embodiment of the present invention. Referring to the figure, the firmware loading device 1 proposed in the present invention is applied to a data processing device 2 having a host circuit board 20 and a case 21 for receiving the host circuit board 20. In the present embodiment, the host circuit board 20 is a motherboard (MB). The data processing device 2 can be selected from the group consisting of a desk top (DT), a notebook (NB), a pocket personal computer (PPC), a server, and a super computer. The firmware loading device 1 comprises a database 10, a first electrically connecting unit 11, a second electrically connecting unit 12, a detecting unit 13 and a control unit 14.

Each of the components of the firmware loading device 1 proposed in the present invention will be provided with a detailed description:

The database 10 is used to store a plurality of firmwares corresponding to a type of the case 21. In other words, although the case 21 with each of the types can be applied to the same host circuit board 20 when being assembled, the edition of the firmware loaded in the host circuit board 20 can be inconsistent depending on the type of the case 21. The database 10 serves to memorize a plurality of firmware corresponding to the case 21 with each of the types. In the present embodiment, the type of the case 21 is assumed as A, B, and C. The firmware is a basic input and output system (BIOS) program. Also, the database 10 is a correlation database.

The first electrically connecting unit 11 is provided on the host circuit board 20. Referring to FIG. 2, in the present embodiment, the first electrically connecting unit 11 is a gold finger and provided at a back surface of the host circuit board. Moreover, the amount of gold finger pins p1, p2 and p3 is fixed but is not limited by the present embodiment.

The second electrically connecting unit 12 which corresponds to the first electrically connecting unit 11 is provided on the case 21. In other words, the second electrically connecting unit 12 is a gold finger matched to the first electrically connecting unit 11. Referring to FIG. 3, in the present embodiment, the amount and the allocation method of gold finger pins p4, p5 and p6 of the second electrically connecting unit 12 correspond to the type of the case 21 as mentioned previously. If the type of the case 21 is A, the gold finger pin of the second electrically connecting unit 12 can be designed as p4. If the type of the case 21 is B, the gold finger pin of the second electrically connecting unit 12 can be designed as p4 and p5. Further, if the type of the case 21 is C, the gold finger pin of the second electrically connecting unit 12 can be designed as p4, p5 and p6. Therefore, the amount and the allocation method of the gold finger pin of the second electrically connecting unit 12 can be designed depending on practical requirements.

The detecting unit 13 serves to detect an electrical connection relationship between the first electrically connecting unit 11 and the second electrically connecting unit 12 via the first electrically connecting unit 11 after the host circuit board 20 is assembled in the case 21 (in other words, after the assembling process of the data processing device 2 has been completed). Also, a power source of the firmware loading device 1 proposed in the present invention can be provided by an electricity unit, or alternatively, by the data processing device 2. In the present embodiment, the power source of the firmware loading device 1 proposed in the present invention is provided by the data processing device 2. In other words, the power source of the data processing device 2 needs to be switched on before the detecting unit 13 can perform a detecting process. As previously mentioned that the detecting unit 13 serves to detect the electrical connection relationship between the first electrically connecting unit 11 and the second electrically connecting unit 12 via the first electrically connecting unit 11, the electrical connection relationship between which one of the gold finger pins p4, p5 and p6 of the second electrically connecting unit 12 and which one of the gold finger pins p1, p2 and p3 of the first electrically connecting unit 11 can be detected via the first electrically connecting unit 11.

The control unit 14 serves to determine an appropriate firmware of the case 21 according to the electrical connection relationship between the first electrically connecting unit 11 and the second electrically connecting unit 12 detected by the detecting unit 13 (In other words, the electrical connection relationship between which one of the gold finger pins p4, p5 and p6 of the second electrically connecting unit 12 and which one of the gold finger pins p1, p2 and p3 of the first electrically connecting unit 11 can be detected). Then, the control unit 14 serves to fetch the firmware appropriate to the case 21 from the database 10 and load the firmware into the host circuit board 20. Accordingly, in the present invention, if the electrical connection relationship detected by the detecting unit 13 is the connection between the gold finger pins p4 and p5 of the second electrically connecting unit 12 and the gold finger pins p1 and p2 of the first electrically connecting unit 11, the type of the case 21 can be determined as B. Thus, the control unit 14 is able to fetch the firmware corresponding to the case 21 with a B type from the database 10 and subsequently load the firmware into the host circuit board 20. Similarly, if the electrical connection relationship detected by the detecting unit 13 is the connection between the gold finger pins p4, p5 and p6 of the second electrically connecting unit 12 and the gold finger pins p1, p2 and p3 of the first electrically connecting unit 11, the type of the case 21 can be determined as C. Thus, the control unit 14 is able to fetch the firmware corresponding to the case 21 with a C type from the database 10 and subsequently load the firmware into the host circuit board 20. (The case with an A type can be deduced from the foregoing examples and thus will not be further described). Additionally, referring to the loading of the firmware into the host circuit board 20, the firmware is loaded into a chip 200 of the host circuit board 20 by the control unit 14.

The technical features and embodiments of the present invention can be well understood by the foregoing description and figures. The firmware loading device proposed in the present invention firstly memorizes a plurality of firmware corresponding to types of the case into a database. Then, a first electrically connecting unit and a corresponding second electrically connecting unit are respectively provided on the host circuit board and the case. A detecting unit subsequently serves to detect an electrical connection relationship between the first electrically connecting unit and the second electrically connecting unit after the host circuit board is assembled in the case. Lastly, a control unit serves to fetch a firmware appropriate to the case from the database and load the firmware into the host circuit board according to the electrical connection relationship between the first electrically connecting unit and the second electrically connecting unit detected by the detecting unit. Therefore, the present invention is able to automatically load a firmware with a correct edition into the data processing device without a complex process, such that human resources can be saved and time requirement can be reduced. Furthermore, the drawback that an operation failure of the data processing device is resulted as the firmware is wrongly loaded due to human errors can be eliminated.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A firmware loading device applied to a data processing device having a host circuit board and a case for receiving the host circuit board, the firmware loading device comprising:
a database for storing a plurality of firmwares corresponding to a type of the case;
a first electrically connecting unit formed on the host circuit board;
a second electrically connecting unit formed on the case, and corresponding to the first electrically connecting unit;
a detecting unit for detecting an electrical connection relationship between the first electrically connecting unit and the second electrically connecting unit after the host circuit board is assembled in the case; and
a control unit for fetching a firmware appropriate for the case from the database and loading the firmware into the host circuit board according to the electrical connection relationship between the first electrically connecting unit and the second electrically connecting unit detected by the detecting unit.

2. The firmware loading device of claim 1, wherein the host circuit board is a motherboard (MB).

3. The firmware loading device of claim 1, wherein the data processing device is selected from the group consisting of a desktop computer (DT), a notebook computer (NB), a pocket personal computer (PPC), a server and a super computer.

4. The firmware loading device of claim 1, wherein the database is a correlation database.

5. The firmware loading device of claim 1, wherein the firmware is a basic input and output system (BIOS) program.

6. The firmware loading device of claim 1, wherein the first electrically connecting unit and the second electrically connecting unit are matched gold fingers.

7. The firmware loading device of claim 5, wherein an amount and allocation arrangement of pins of the gold finger of the second electrically connecting unit are designed corresponding to the type of the case.

8. The firmware loading device of claim 6, wherein the allocation arrangement of the pins of the gold finger of the second electrically connecting unit is designed corresponding to the type of the case.

9. The firmware loading device of claim 1, wherein the detecting unit detects the electrical connection relationship between the first electrically connecting unit and the second electrically connecting unit via the first electrically connecting unit.

10. The firmware loading device of claim 1, wherein the firmware is loaded into a chip an the host circuit board.

11. The firmware loading device of claim 1, wherein a power source of the firmware loading device is provided by an electricity unit.

12. The firmware loading device of claim 1, wherein a power source of the firmware loading device is provided by the data processing device.
